(19) United States
(12) Patent Application Publication
(10) Pub. No.: US 2014/0036436 A1
(43) Pub. Date: Feb. 6, 2014

(54) DOCKING STATION FOR TABLET COMPUTER

(71) Applicant: HON HAI PRECISION INDUSTRY CO., LTD., New Taipei (TW)

(72) Inventor: CHUNG-HSING YANG, New Taipei (TW)

(73) Assignee: HON HAI PRECISION INDUSTRY CO., LTD., New Taipei (TW)

(21) Appl. No.: 13/892,696

(22) Filed: May 13, 2013

(30) Foreign Application Priority Data
Aug. 1, 2012 (TW) 101127869

(51) Int. Cl. G06F 1/16

(52) U.S. Cl. CPC G06F 1/1632
USPC 361/679.41

(57) ABSTRACT

An assembly includes a tablet computer and a docking station. The tablet computer includes a first connection hole defined on a bottom edge of the tablet computer. The docking station includes a base and a supporting seat. The base includes a base body and a control module. The supporting seat is pivotally mounted on the base body. The supporting seat includes a supporting portion. A connecting post is formed on the supporting portion. The connecting post is electrically connected to the control module. The supporting portion supports the tablet computer thereon with the connecting post inserted in the first connecting hole. The connecting post is electrically connected to the tablet computer via the first connecting hole, and the control module is configured to control the tablet computer.

### BACKGROUND

1. Technical Field

The present disclosure relates to docking stations, and more particularly to a docking station for receiving a tablet computer.

2. Description of Related Art

A tablet computer is a mobile computer and often integrated with a flat touchscreen and may be primarily operated by touching the screen. In the tablet computer, the processor may be a part of the screen. The tablet computer usually provides a user interface through the screen. The user may enter text directly on the screen by using a digital pen, fingers, stylus, etc. However, because the tablet computer does not have a support stand, it can be inconvenient to use the tablet computer when it is laying flat.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a docking station and a tablet computer.

FIG. 2 is similar to FIG. 1, but viewed from another aspect.

FIG. 3 is an assembled view of the docking station and the tablet computer of FIG. 1 in an unfolded position.

FIG. 4 is an assembled view of the docking station and the tablet computer of FIG. 1 in a folded position.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

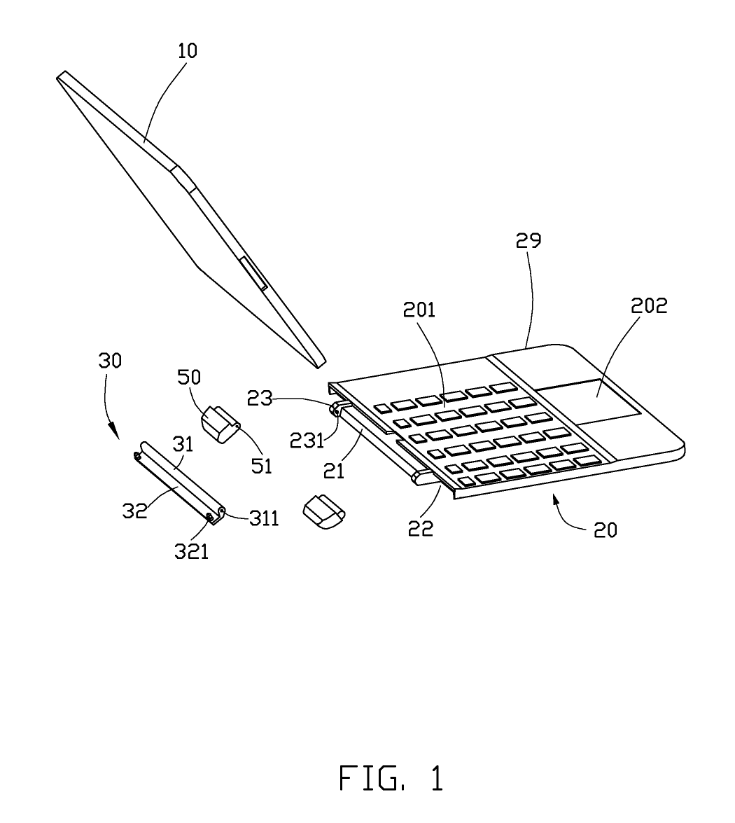

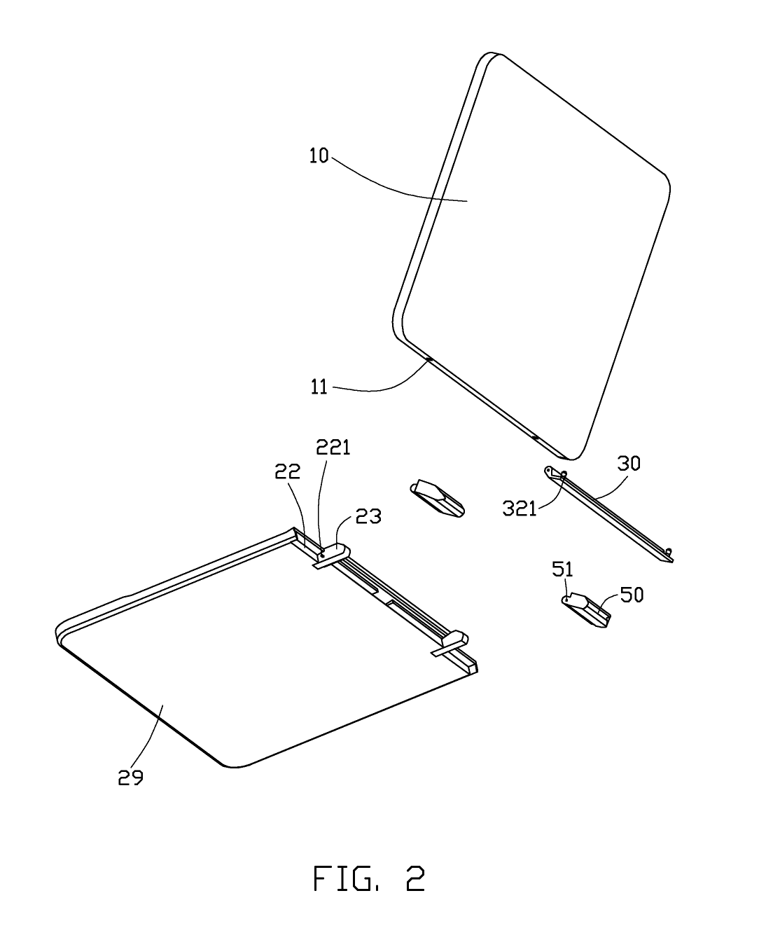

FIGS. 1 and 2 show one embodiment of a docking station for supporting a tablet computer 10. The docking station includes a base 20, a supporting seat 30, and two rotating feet 50.

A bottom end of the tablet computer 10 defines two first connection holes 11.

The base 20 comprises a base body 29 and a control module. In one embodiment, the control module includes a plurality of keys 201 and a touch pad 202. The base body 29 defines two receiving cutouts 22 on a rear end of the base body 29. A protrusion 21 is located between the two receiving cutouts 22. A pivoting shaft 221 is located in each of the two receiving cutouts 22. Opposite ends of the protrusion 21 connect two connecting blocks 23. Each of the two connecting blocks 23 includes a connecting pin 231 electrically connected to the plurality of keys 201 and the touch pad 202 in an inner portion of the base body 29 to transmit control signals.

The supporting seat 30 includes a rotating portion 31 and a supporting portion 32. The supporting portion 32 includes two connecting posts 321 corresponding to the two first connection holes 11 of the tablet computer 10. The connecting posts 321 can be inserted in the connection holes 11 to electrically communicate with the tablet computer 10. The rotating portion 31 defines two second connection holes 311. The second connection holes 311 are electrically connected to the connecting posts 321 in an inner portion of the supporting seat 30.

Each rotating foot 50 defines a pivoting hole 51 corresponding to the pivoting shaft 221 of the base body 29.

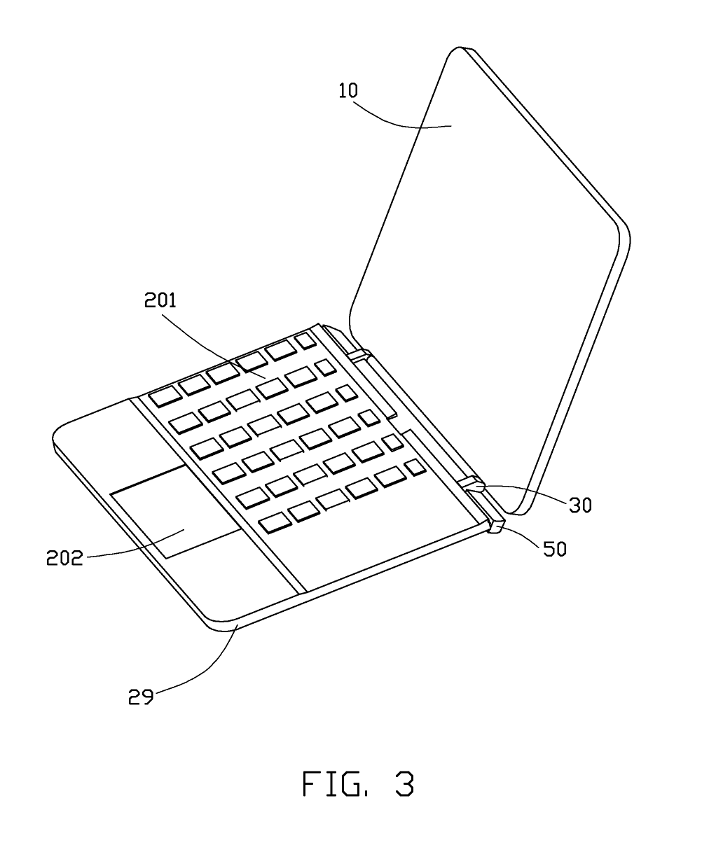

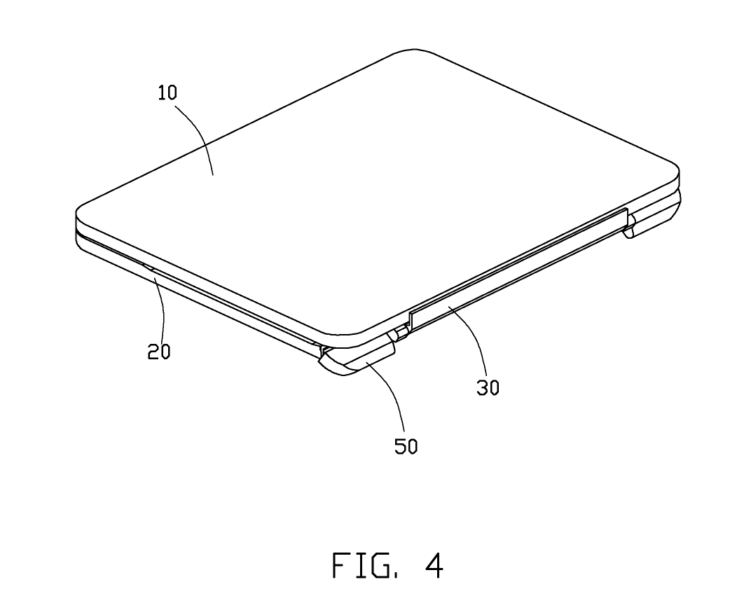

Referring to FIGS. 1 to 4, in assembly, the connecting pins 231 of the base body 29 are pivotably inserted into the second connection holes 311 of the supporting seat 30 to pivotably mount the supporting seat 30 on the base body 29. Simultaneously, the supporting seat 30 is electrically connected to the base body 29. In succession, the rotating feet 50 are moved in the receiving cutout 22. The pivoting shaft 221 is pivotably inserted into the pivoting holes 51 of the rotating feet 50 to pivotably mount the rotating feet 50 to the base body 29. Thereby, the docking station is assembled.

To use the docking station to support the tablet computer 10, the tablet computer 10 is placed on the supporting portion 32 of the supporting seat 30 with the connecting posts 321 of the supporting seat 30 inserted in the first connection holes 11 of the tablet computer 10. Insertion of the connecting posts into the first connection holes 11 accomplishes both mechanical and electrical connection of the tablet computer 10 to the docking station. The tablet computer 10 is connected to the plurality of keys 201 and the touch pad 202 via the first connection holes 11, the connecting posts 321, the second connection holes 311, and the connecting pins 231. Therefore, the plurality of keys 201 and the touch pad 202 can be used to operate the tablet computer 10.

After the tablet computer 10 is mounted on the supporting seat 30, the tablet computer 10 can rotate relative to the supporting seat 30 between a folded position and an unfolded position. When folded, the tablet computer 10 overlaps the base body 29. Unfolded, the tablet computer 10 and the base body 29 form an obtuse angle. Further, the rotating feet 50 can rotate to adjust an inclined angle of the base body 29.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An assembly, comprising:
a tablet computer comprising a first connection hole defined in the tablet computer;
a base comprising a base body and a control module; and
a supporting seat pivotally mounted on the base body, the supporting seat comprising a supporting portion and a connecting post formed on the supporting portion, wherein the connecting post is electrically connected to the control module, the supporting portion is configured to support the tablet computer with the connecting post inserted in the first connecting hole, the connecting post is electrically connected to the tablet computer via the first connecting hole, and the control module is configured to operate the tablet computer.

2. The assembly of claim 1, further comprising a protrusion located on the base body, and the supporting seat is pivotally mounted on the protrusion.

3. The assembly of claim 2, wherein the supporting seat further comprises a rotating portion, the rotating portion defines a pair of second connecting holes, and the pair of second connecting holes are electrically connected to the connecting post; opposite ends of the protrusion connect two connecting blocks, the two connecting blocks comprises two connecting pins electronically connected to the control module, and the two connecting pins are pivotally inserted to the pair of second connecting holes and electrically connected to the connecting post via the pair of second connecting holes.

4. The assembly of claim 2, wherein the base body defines a pair of receiving cutouts adjacent opposite sides of the protrusion, the base body further comprises a pair of rotating feet pivotally mounted in the pair of receiving cutouts, and the pair of rotating feet is configured to rotate to adjust an inclined angle of the base body.

5. The assembly of claim 4, wherein the base body further comprises a pivoting shaft formed in each of the pair of receiving cutouts, each of the pair of rotating feet defines a pivoting hole, and the pivoting shaft is pivotally inserted in the pivoting hole.

6. The assembly of claim 1, wherein the tablet computer is configured to rotate together with the supporting seat between a folded position and an unfolded position, the tablet computer is configured to be overlapped on the base body at the folded position, and configured to form an obtuse angle with the base body at the unfolded position.

7. The assembly of claim 1, wherein the control module comprises a plurality of keys and a touch pad.

8. An assembly, comprising:
a tablet computer defining a first connection hole;
a base comprising a base body and a control module, the base body comprising a connecting pin electrically connected to the control module; and
a supporting seat defining a second connection hole, the supporting seat comprising a connecting post electrically connected to the second connection hole;
wherein the tablet computer is received on the supporting seat with the connecting post electrically connecting to the first connection hole, and the supporting seat is pivotally mounted on the base body with the connecting pin pivotally inserted in and electrically connected to the second connection hole to electrical connect the tablet computer to the control module of the base.

9. The assembly of claim 8, wherein the connecting post is inserted in the first connecting hole to mount the tablet computer on the supporting seat.

10. The assembly of claim 8, further comprising a protrusion formed on a rear end of the base body, and the supporting seat is pivotally mounted on the protrusion.

11. The assembly of claim 10, wherein the supporting seat further comprises a rotating portion, the second connection hole is defined in the rotating portion, the protrusion connects to a connecting block, the connecting pin is formed on the connecting block, and the connecting pin is pivotally inserted to the second connecting hole.

12. The assembly of claim 10, wherein the base body defines a pair of receiving cutouts adjacent opposite sides of the protrusion, the base body further comprises a pair of rotating feet pivotally mounted in the pair of receiving cutouts, and the pair of rotating feet is configured to rotate to adjust an inclined angle of the base body.

13. The assembly of claim 12, wherein the base body further comprises a pivoting shaft formed in each of the pair of receiving cutouts, each of the pair of rotating feet defines a pivoting hole, and the pivoting shaft is pivotally inserted in the pivoting hole.

14. The assembly of claim 8, wherein the tablet computer is configured to rotate together with the supporting seat between a folded position and an unfolded position, the tablet computer is configured to overlap on the base body at the folded position, and configured to form an obtuse angle with the base body at the unfolded position.

15. The assembly of claim 8, wherein the control module comprises a plurality of keys and a touch pad.
